(19) United States
(12) Patent Application Publication
(10) Pub. No.: US 2013/0194387 A1
(43) Pub. Date: Aug. 1, 2013

(54) IMAGE PROCESSING METHOD, IMAGE PROCESSING APPARATUS AND IMAGE-PICKUP APPARATUS

(71) Applicant: Canon Kabushiki Kaisha, Tokyo (JP)

(72) Inventor: Koshi Hatakeyama, Tokyo (JP)

(73) Assignee: CANON KABUSHIKI KAISHA, Tokyo (JP)

(21) Appl. No.: 13/650,854

(22) Filed: Oct. 12, 2012

(30) Foreign Application Priority Data
Feb. 1, 2012 (JP) 2012-019436
Oct. 11, 2012 (JP) 2012-226445

(51) Int. Cl. H04N 13/02

(52) U.S. Cl. CPC H04N 13/02
USPC 348/46

(57) ABSTRACT

The image processing method includes acquiring parallax images produced by image capturing, performing position matching of the parallax images to calculate difference between the parallax images, and deciding, in the difference, an unnecessary image component different from an image component corresponding to the parallax. The method is capable of accurately deciding the unnecessary image component included in a captured image without requiring image capturing multiple times.

### BACKGROUND OF THE INVENTION

1. Field of the Invention

The present invention relates to an image processing technique to improve image quality of captured images.

2. Description of the Related Art

In image capturing by image pickup apparatuses such as cameras, part of light entering an image capturing optical system is often reflected by a lens surface or a lens holding member to reach an image sensor surface as unnecessary light. The unnecessary light reaching the image sensor surface forms a high-density spot image or spreads over a wide area of an object image to appear as ghost or flare as an unnecessary image component in a captured image.

Moreover, in a telephoto lens whose most-object side lens is a diffractive optical element for correcting longitudinal chromatic aberration or chromatic aberration of magnification, light emitting from a high-luminance object such as a sun existing outside an image capturing field angle and entering the diffractive optical element sometimes generates dim unnecessary light. Such unnecessary light also appears as an unnecessary image component in the captured image.

Thus, methods of optically reducing the unnecessary light or of removing the unnecessary component by digital image processing are conventionally proposed. Japanese Patent Laid-Open No. 2008-054206 discloses, as one of the methods of removing the unnecessary component by digital image processing, a method of detecting ghost from a difference image showing difference between an in-focus image captured through an image capturing optical system in an in-focus state for an object and a defocused image captured through the image capturing optical system in a defocused state for the object.

However, the method disclosed in Japanese Patent Laid-Open No. 2008-054206 requires image capturing multiple times including image capturing in the in-focus state and image capturing in the defocused state. Therefore, the method is not suitable for still image capturing of moving objects and for moving image capturing.

### BRIEF SUMMARY OF THE INVENTION

The present invention provides an image processing method, an image processing apparatus and an image pickup apparatus capable of accurately deciding an unnecessary image component included in a captured image without requiring image capturing multiple times.

The present invention provides as one aspect thereof an image processing method including a step of acquiring parallax images having parallax and produced by image capturing of an object, performing position matching of the parallax images to calculate difference between the parallax images, and deciding, in the difference, an unnecessary image component different from an image component corresponding to the parallax.

The present invention provides as another aspect thereof an image processing apparatus including an image acquiring part configured to acquire parallax images having parallax and produced by image capturing of an object, a difference calculating part configured to perform position matching of the parallax images to calculate difference between the parallax images, and an unnecessary image component deciding part configured to decide, in the difference, an unnecessary image component different from an image component corresponding to the parallax.

The present invention provides as still another aspect thereof an image pickup apparatus including an image capturing system configured to perform image capturing of an object to produce parallax images having parallax, and the above image processing apparatus.

The present invention provides as yet still another aspect thereof a non-transitory computer-readable storage medium storing an image processing program for causing a computer to execute an image processing operation. The image processing operation includes acquiring parallax images having parallax and produced by image capturing of an object, performing position matching of the parallax images to calculate difference between the parallax images, and deciding, in the difference, an unnecessary image component different from an image component corresponding to the parallax.

Other aspects of the present invention will become apparent from the following description and the attached drawings.

### BRIEF DESCRIPTION OF THE DRAWINGS

FIGS. 1A to 1F show a procedure of an image processing method that is Embodiment 1 of the present invention.

FIG. 2 shows a relationship between light receiving portions of an image sensor in an image capturing system of an image pickup apparatus using the image processing method of Embodiment 1 and a pupil of an image capturing optical system of the image pickup apparatus.

FIG. 3 schematically shows the image capturing system.

FIG. 4 is a block diagram showing a configuration of the image pickup apparatus.

FIGS. 5A and 5B show the image capturing optical system of the image pickup apparatus and unnecessary light generated therein.

FIG. 6 shows the unnecessary light passing through an aperture stop of the image capturing optical system shown in FIG. 5.

FIGS. 7A and 7B show relationships between the aperture stop of the image capturing optical system and the unnecessary light.

FIG. 8 shows a high-luminance area in an image and a target area for deciding the unnecessary light.

FIG. 9 is a flowchart showing the procedure of the image processing method.

FIG. 10 is a flowchart showing a procedure of an image processing method that is Embodiment 2 of the present invention.

FIG. 11 is a flowchart showing a procedure of an image processing method that is Embodiment 3 of the present invention.

FIG. 12 is a flowchart showing a procedure of a modified example of the image processing method of Embodiment 3.

FIG. 13 shows determination whether or not to perform an image process using an image pickup condition of the image capturing optical system.

FIG. 14 shows distance information for objects.

FIG. 15 shows an image capturing optical system of an image pickup apparatus using an image processing method that is Embodiment 4 of the present invention and unnecessary light generated therein.

FIG. 16 shows the unnecessary light passing through an aperture stop of the image capturing optical system shown in FIG. 15.

FIGS. 17A to 17F show a procedure of the image processing method of Embodiment 4.

FIG. 18 shows an image capturing system of an image pickup apparatus that is Embodiment 5 of the present invention.

FIG. 19 shows an image capturing system of another image pickup apparatus of Embodiment 5.

FIG. 20 shows an image capturing system of further another image pickup apparatus of Embodiment 5.

FIG. 21 shows a conventional type image sensor.

FIGS. 22A and 22B show an image acquired by the image capturing system shown in FIG. 18.

FIG. 23 shows an image acquired by the image capturing system shown in FIGS. 19 and 20.

FIG. 24 shows another image capturing example of Embodiment 5.

FIG. 25 shows another image pickup apparatus of Embodiment 5.

FIGS. 26A and 26B respectively shows examples of unnecessary image components generated by a pixel defect and by dust adhesion in Embodiment 6 of the present invention.

### DETAILED DESCRIPTION OF THE EMBODIMENTS

Exemplary embodiments of the present invention will hereinafter be described with reference to the accompanying drawings.

An image pickup apparatus using in each embodiment of the present invention has an image capturing system introducing light fluxes passing through mutually different areas of a pupil of an image capturing optical system to mutually different light-receiving portions (pixels) of an image sensor to cause the light-receiving portions to perform photoelectric conversion of the light fluxes, which enables production of parallax images having parallax.

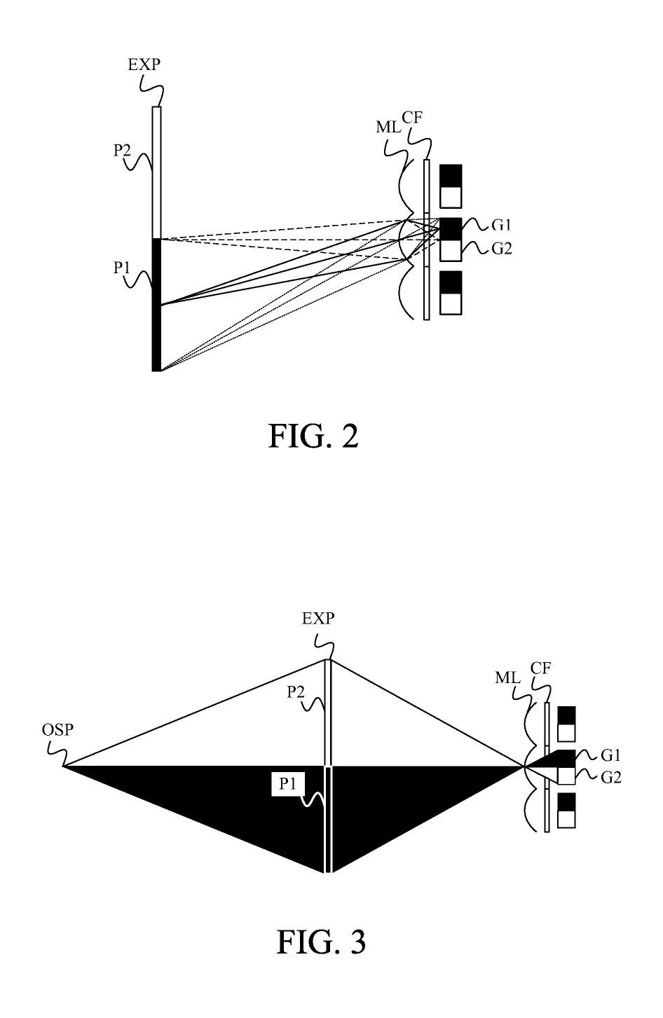

FIG. 2 shows a relationship between the light-receiving portions of the image sensor in the image capturing system and the pupil of the image capturing optical system. In FIG. 2, reference character ML denotes a microlens, CF a color filter, and EXP an exit pupil of the image capturing optical system. Reference characters G1 and G2 denote light-receiving portions (hereinafter respectively referred to as “a G1 pixel” and “a G2 pixel”). One G1 pixel and one G2 pixel form a pair of pixels.

The image sensor is provided with a plurality of the paired G1 and G2 pixels (pixel pairs). The paired G1 and G2 pixels are provided with a conjugate relationship with the exit pupil EXP by one microlens ML provided for the paired G1 and G2 pixels (that is, for each pixel pair). In the following description, a plurality of the G1 pixels is hereinafter referred to as “a G1 pixel group” and a plurality of the G2 pixels is hereinafter referred to as “a G2 pixel group”.

FIG. 3 schematically shows a hypothetical image capturing system including, instead of the micro lens ML shown in FIG. 2, a thin lens at a position of the exit pupil. The G1 pixel receives a light flux passing through a P1 area of the exit pupil EXP, and the G2 pixel receives a light flux passing through a P2 area of the exit pupil EXP. Reference character OSP denotes an object point. It is not necessarily needed that an object exists at the object point OSP. The light fluxes passing through this object point enter the G1 or G2 pixel depending on areas (positions) of the exit pupil EXP through which the light fluxes pass.

The pass of the light fluxes through the mutually different areas of the pupil corresponds to separation of the light fluxes entering from the object point OSP according to their angles (parallax). That is, an image produced by using an output signal from the G1 pixel provided for one microlens ML and an image produced by using an output signal from the G2 pixel provided for the same microlens ML form a plurality (pair) of parallax images having the parallax. In the following description, receiving of the light fluxes passing through the mutually different areas of the pupil by the mutually different light-receiving portions (pixels) is also referred to as “pupil division”.

Moreover, in FIGS. 2 and 3, even if a positional shift of the exit pupil EXP or the like makes the above-mentioned conjugate relationship not perfect or partially overlaps the P1 and P2 areas each other, each embodiment treats acquired images as the parallax images.

### Embodiment 1

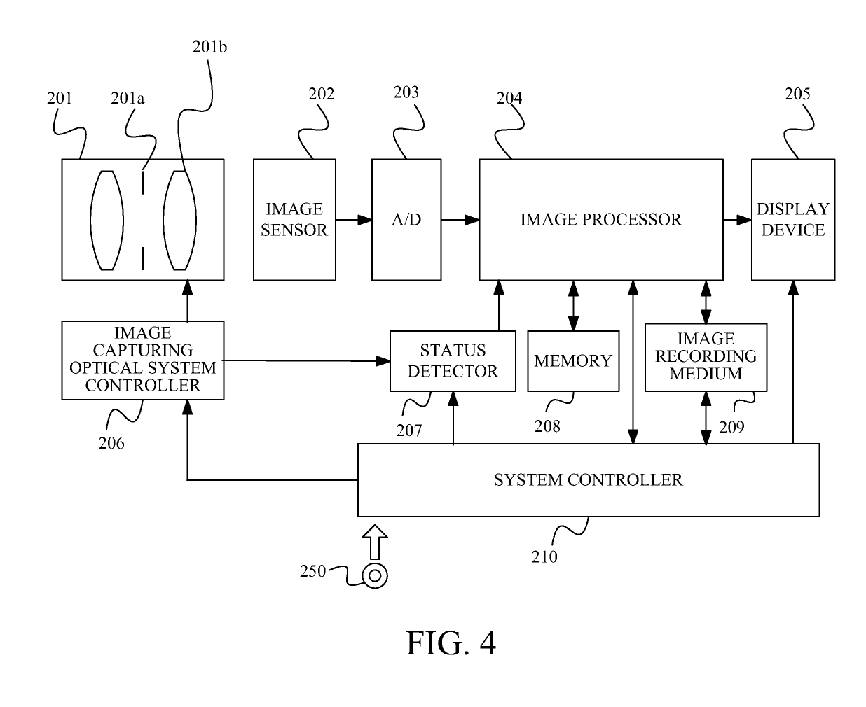

FIG. 4 shows a basic configuration of an image pickup apparatus using an image processing method that is a first embodiment (Embodiment 1) of the present invention. An image capturing optical system 201 including an aperture stop 201a and a focus lens 201b causes light from an object (not shown) to form an image on an image sensor 202. The image sensor 202 constituted by a photoelectric conversion element such as a CCD sensor or a CMOS sensor receives, as described with reference to FIGS. 2 and 3, the light fluxes passing through the mutually different areas (hereinafter referred to as “pupil areas”) of the pupil of the image capturing optical system 201 at the pixels (light-receiving portions) corresponding to the pupil areas. That is, the image sensor 202 performs the pupil division.

Analog electrical signals produced by the photoelectric conversion of the light fluxes by the image sensor 202 are converted into digital signals by the A/D converter 203, and the digital signals are input to an image processor 204. The image processor 204 performs, on the digital signals, general image processes, an unnecessary light decision process and a correction process for reducing or removing the unnecessary light to produce an output image. The image processor 204 corresponds to an image processing apparatus provided in the image pickup apparatus. Moreover, the image processor 204 serves as an image acquiring part to acquire (produce) parallax images, a difference calculating part to calculate difference between the parallax images and an unnecessary image component deciding part to decide an unnecessary image component.

The output image produced the by image processor 204 is stored in an image recording medium 209 such as a semiconductor memory or an optical disk. The output image may be displayed on a display device 205.

A system controller 210 controls operations of the image sensor 202, the image processor 204 and the aperture stop 201a and the focus lens 201b in the image capturing optical system 201. Specifically, the system controller 210 outputs a control instruction to an image capturing optical system controller 206. The image capturing optical system controller 206 controls mechanical drive of the aperture stop 201a and focus lens 201b in the image capturing optical system 201 in response the control instruction. Thus, an aperture diameter of the aperture stop 201a is controlled according to an aperture value (F-number) set by the system controller 210. A current aperture diameter of the aperture stop 201a and a current position of the focus lens 201b are detected by a status detector 207 through the image capturing optical system controller 206 or the system controller 210 to input to the image processor 204. A position of the focus lens 201b is controlled to perform focusing according to object distances by an autofocus (AF) system (not shown) and a manual focus mechanism (not shown). Although the image capturing optical system 201 shown in FIG. 4 is constituted as part of the image pickup apparatus, it may be interchangeable with respect to an image pickup apparatus such as a single-lens reflex camera.

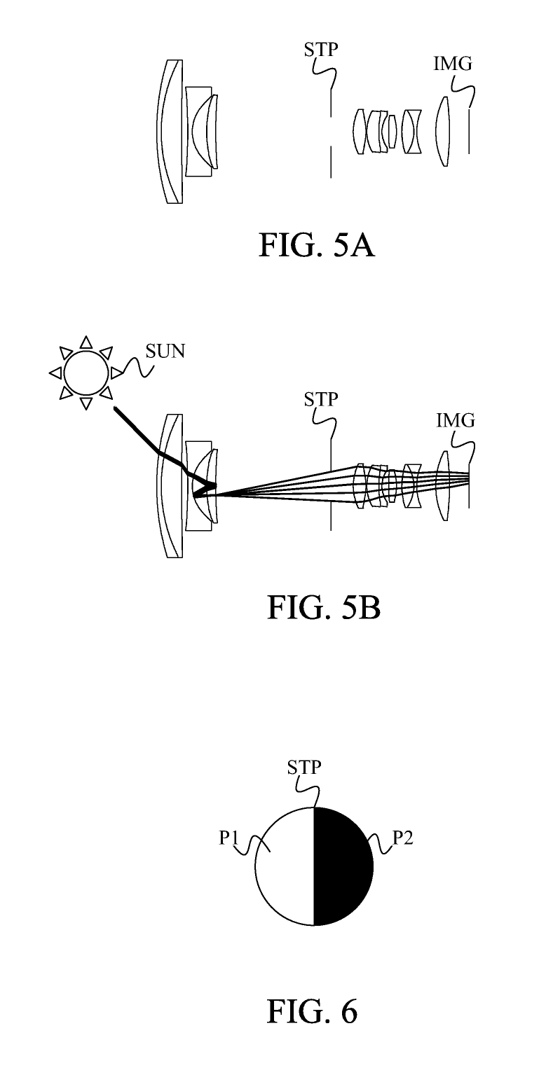

FIG. 5A shows a specific configuration example of the image capturing optical system 201. Reference character STP denotes an aperture stop. Reference character IMG denotes an image pickup surface where the image sensor 202 shown in FIG. 4 is disposed. FIG. 5B shows a state in which high-intensity light from a sun SUN as an example of high-luminance objects enters the image capturing optical system and is reflected by surfaces of lenses constituting part of the image capturing optical system to reach the image pickup surface IMG as unnecessary light (ghost or flare).

Moreover, FIG. 6 shows, of the aperture stop STP (in other words, of the exit pupil of the image capturing optical system), areas P1 and P2 (hereinafter referred to as “P1 and P2 pupil areas) through which light fluxes entering the G1 and G2 pixels shown FIG. 3 respectively pass. Although the light (light flux) from the high-luminance object passes through an entire area of the aperture stop STP, the entire area is divided into the P1 and P2 pupil areas through which the light fluxes reaching the G1 and G2 pixels respectively pass.

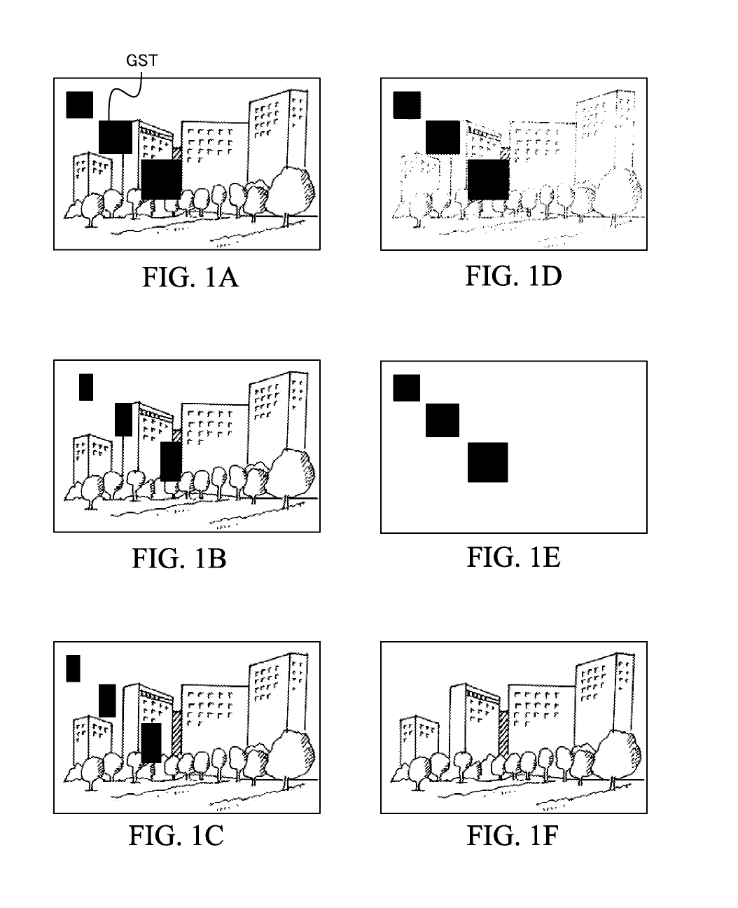

Description will be made of a method of deciding an unnecessary image component that is an image component appearing, due to photoelectric conversion of the unnecessary light, in a captured image produced by image capturing by the image pickup apparatus thus configured, with reference to FIGS. 1A to 1F.

FIG. 1A shows a captured image produced by image capturing without the pupil division. This captured image includes objects such as buildings and trees existing therearound. Black rectangular areas with reference character GST show an unnecessary image component that is an image component formed by the unnecessary light (ghost). Although the unnecessary image component GST in the figure is blacked out, the objects are actually partially seen through the unnecessary image component GST. This applies also to other embodiments described later.

FIGS. 1B and 1C show paired parallax images acquired as results of photoelectric conversion of the light fluxes passing through the P1 and P2 pupil areas by the G1 and G2 pixel groups. These paired parallax images have difference (difference components) corresponding to parallax in image components of the objects (buildings and trees). Although the unnecessary image components GST schematically shown as the black rectangles are also included in the parallax images, positions of the unnecessary image components are different between the parallax images. Moreover, although FIGS. 1B and 1C show the paired parallax images in which the unnecessary image components GST are separated without overlap, the unnecessary image components GST may mutually overlap and thereby have a luminance difference. That is, it is only necessary that positions or luminances of the unnecessary image components GST in the paired parallax images be mutually different.

FIG. 1D shows an image produced by position matching (overlaying) of these paired parallax images. A method of the position matching will be described later. This image (hereinafter referred to as “a difference image”) includes a parallax component of the objects and the above-described unnecessary image component, both of which are difference of the paired parallax images. The difference is hereinafter also referred to as “difference information”. The parallax component of the objects (hereinafter referred to as “an object parallax component”) is a difference component corresponding to the parallax between the image components of the objects (buildings and trees) included in the paired parallax images shown in FIGS. 1B and 1C.

FIG. 1E shows the unnecessary image component remaining after a process to remove the object parallax component has been performed on the difference image shown in FIG. 1D. Performing such a process causing the unnecessary image component to remain (in other words, a process isolating or extracting the unnecessary image component) enables decision of the unnecessary image component.

Moreover, a correction process is performed to remove or reduce the unnecessary image component thus decided on an image(s) to be output (such as a reconstructed image produced by combination of the paired G1 and G2 pixels, or the paired parallax images), which enables acquisition of an output image including almost no unnecessary image component, as shown in FIG. 1F.

The decision of the unnecessary image component requires, as described above, the process to produce the difference image and the process to isolate the unnecessary image component from the object parallax component, which decreases image processing speed to production of the output image and deteriorates image quality due to erroneous detection. Thus, each embodiment makes a determination of whether or not to perform the above-mentioned image process to decide and remove the unnecessary image component, by using (with reference to) image capturing condition information of the image pickup apparatus and determination information, which are described later. The determination may be made only of whether or not to perform the process to decide the unnecessary image component. This is because, if the process to decide the unnecessary image component does not decide it, the process to remove it is not needed.

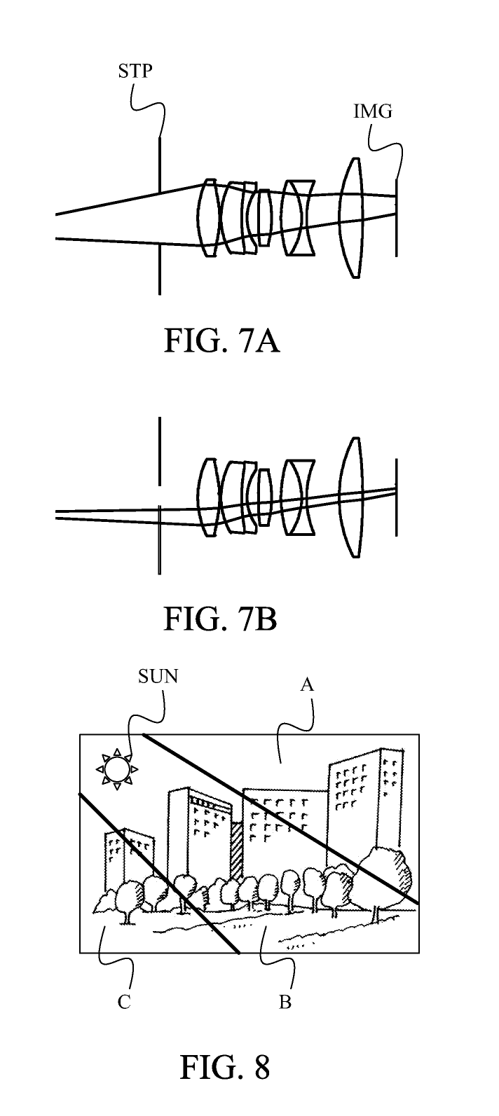

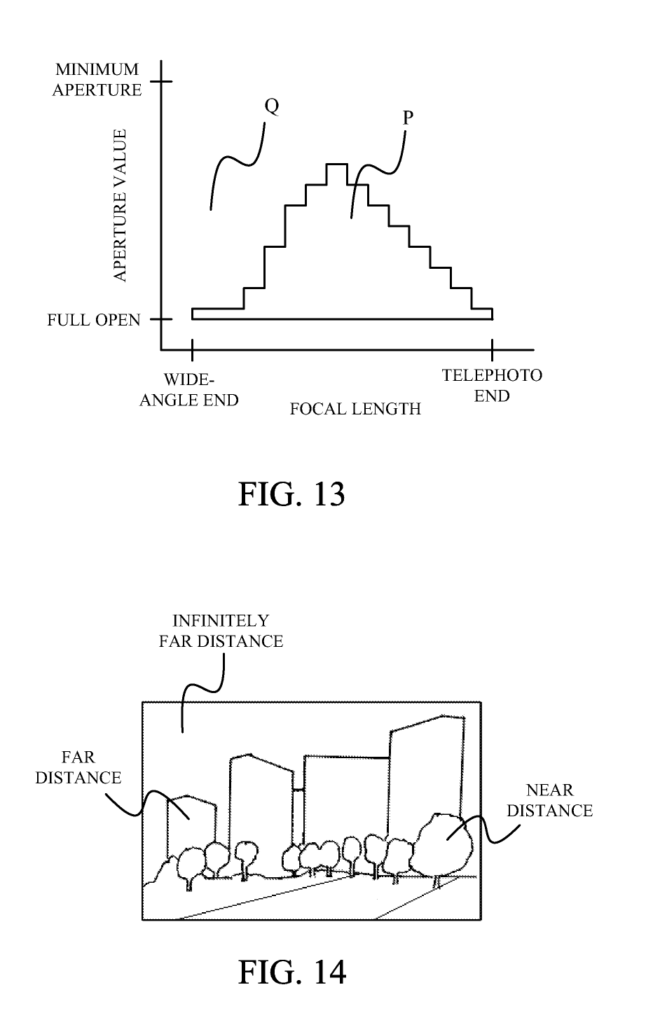

FIG. 13 shows the determination information. In FIG. 13, a horizontal axis shows focal length of the image capturing optical system when the image capturing optical system is a zoom optical system, and a vertical axis shows aperture value. Image capturing performed in an image capturing condition area P surrounded by a solid line provides a high possibility of generating the unnecessary image component, and image capturing performed in an image capturing condition area Q provides a low possibility thereof. FIGS. 7A and 7B show unnecessary lights transmitted through the image capturing optical system in mutually different image capturing conditions. Lenses existing on an object side further than the aperture stop STP are omitted in FIGS. 7A and 7B. In a case shown in FIG. 7A the unnecessary light reaches the image pickup surface IMG even though the aperture stop STP is narrowed. On the other hand, in a case shown in FIG. 7B the unnecessary light does not reach the image pickup surface IMG because it is blocked by the aperture stop STP. Thus, in the exemplified case shown in FIG. 7B, narrowing the aperture stop STP decreases the possibility that the unnecessary image component is generated.

Therefore, this embodiment performs, in the case where the image capturing condition is included in the image capturing condition area P, the image process to decide and remove the unnecessary image component, and on the other hand does not perform it in the case where the image capturing condition is included in the image capturing condition area Q, which enables avoidance of the undesirable decrease of the image processing speed and avoidance of the deterioration of the image quality due to erroneous detection.

A boundary of the image capturing condition areas P and Q and a division number of the image capturing condition areas are not limited to those shown in FIG. 13, and may be changed according to characteristics of the image pickup apparatus. Moreover, the image capturing condition areas may be divided depending not only on the possibility of generating the unnecessary image component, but also on difficulty of preliminarily deciding the unnecessary image component. Furthermore, the image capturing condition includes not only the focal length and the aperture value, but also other parameters such as an image capturing distance.

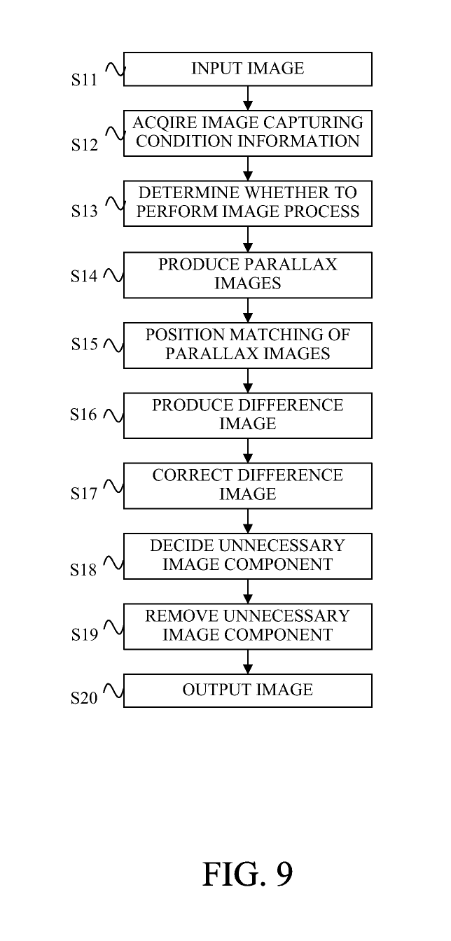

FIG. 9 shows a flowchart showing a procedure of the above-described process (image process) to decide the unnecessary image component. The system controller 210 and the image processor 204 perform this process according to an image processing program as a computer program.

At step S11, the system controller 210 controls the image capturing system including the image capturing optical system 201 and the image sensor 202 to perform image capturing of an object.

At step S12, the system controller 210 causes the status detector 207 to acquire the image capturing condition information.

At step S13, the system controller 210 determines, by using the image capturing condition and the determination information, whether or not to perform the image process to decide and remove the unnecessary image component.

If determining not to perform the image process to decide and remove the unnecessary image component at step S13, the system controller 210 produces an output image by performing predetermined processes such as a development process and an image correction process. The system controller 210 may produce parallax images as needed, on other purposes than the decision and removal of the unnecessary image component. Description will hereinafter be made of a case where a determination to perform the image process to decide and remove the unnecessary image component is made.

At step S14, the system controller 210 causes the image processor 204 to produce a pair of parallax images as input images by using digital signals converted by the A/D converter 203 from analog signals output from the G1 and G2 pixel groups of the image sensor 202.

Next, at step S15, the image processor 204 performs the position matching of the paired parallax images. The position matching can be performed by relatively shifting one of the paired parallax images with respect to the other one thereof to decide a shift position where correlation between these images becomes maximum. The position matching can also be performed by deciding a shift position where a square sum of difference components between the paired parallax images becomes minimum. Moreover, the shift position decision for the position matching may be performed by using in-focus areas of the parallax images.

In addition, the shift position decision for the position matching may be performed by detecting edges in each of the parallax images and by using the detected edges. Since edges with high contrast are detected in an in-focus area and edges with low contrast are difficult to be detected in an out-of-focus area such as a background area, the shift position decision may be performed inevitably focusing on the in-focus area.

Furthermore, performing the edge detection on the unnecessary image component GST shown in FIGS. 1B and 1C detects only its outline, so that influence of the unnecessary image component GST on the entire image is small when performing the position matching by the above-mentioned maximization of the correlation or minimization of the square sum of the difference components.

Next, at step S16, the image processor 204 calculates difference between the paired parallax images to produce the above-mentioned difference image. In a case where light fluxes of the unnecessary light reaching the image pickup surface pass through mutually different pupil areas of the image capturing optical system, the unnecessary image components are generated at different positions in the parallax images as shown in FIGS. 1B and 1C, and an absolute value of difference between the unnecessary image components is greater than an absolute value of the object parallax component as shown in FIG. 1D.

Thus, at step S17, the image processor 204 corrects the difference image such that only difference in the difference image equal to or greater than (or difference greater than) a predetermined threshold which is greater than the absolute value of the object parallax component, that is, the unnecessary image component remains. This correction may be performed by an image processing technique such as smoothing for suppressing detection noise. Moreover, the correction can be performed by removing thin lines and isolated points on a basis of a characteristic that the unnecessary image component has a larger area than that of the object parallax component as shown in FIG. 1D. Thus, as shown in FIG. 1E, the image produced by isolating (extracting) only the unnecessary image component from the difference image.

Next, at step S18, the image processor 204 decides a remaining image component in the image acquired at step S17 as the unnecessary image component.

Next, at step S19, the image processor 204 performs a correction process to remove (or reduce) the unnecessary image component from an image to be output. In this embodiment, the image processor 204 produces, as the image to be output, a reconstructed image that is acquired by combining the G1 and G2 pixels shown in FIG. 3 to produce one pixel. When producing the reconstructed image, the image processor 204 uses in an image area including the unnecessary image component (hereinafter referred to as “an unnecessary component image area”) a value of one pixel of the G1 and G2 pixels which does not include the unnecessary image component. Thereby, as shown in FIG. 1F, an output image in which the unnecessary image component is removed (reduced) can be produced. In the unnecessary component image area, it is desirable to perform gain adjustment.

The image processor 204 may produce such an output image in which the unnecessary image component is removed (reduced) by another method that combines the entire parallax image acquired by using the G1 pixel group with the entire parallax image acquired by using the G2 pixel group to produce a reconstructed image and subtracts therefrom the above-mentioned unnecessary component image area.

Finally, at step S20, the system controller 210 stores the output image in which the unnecessary image component is removed (reduced) in the image recording medium 209 and displays the output image on the display device 205.

As described above, this embodiment can decide the unnecessary image component, which is generated due to the unnecessary light (ghost), by using the parallax images produced by one image capturing. That is, this embodiment can decide the unnecessary image component included in a captured image without performing image capturing multiple times. Moreover, this embodiment determines whether or not to perform the decision of the unnecessary image component by using the image capturing condition, and therefore can avoid that the image processing speed is decreased and the image quality is deteriorated due to erroneous detection by not performing an unnecessary image process in the case where it is clear that no unnecessary image component is generated. Thus, this embodiment can provide a high quality captured image in which the decided unnecessary image component is sufficiently removed or reduced.

### Embodiment 2

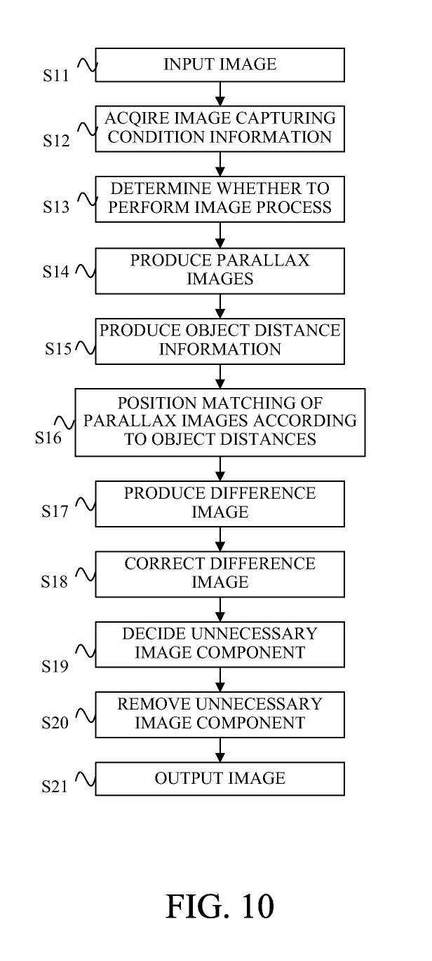

FIG. 10 shows a flowchart showing a modified example (as a second embodiment of the present invention) of the above-described image process to decide the unnecessary image component.

Processes at steps S11 to S14 are same as those in Embodiment 1, so that description thereof is omitted.

At step S15, the system controller 210 causes the image processor 204 to produce information on distances to the objects (hereinafter referred to as “object distance information”) by using the parallax images. A method acquiring the object distance information from parallax images is well-known, so that description thereof is omitted. FIG. 14 shows the object distance information acquired from the parallax images shown in FIGS. 1B and 1C. FIG. 14 shows several object distances from a near distance to an infinitely far distance.

Next, at step S16, the image processor 204 performs position matching of the paired parallax images by using the object distance information. The position matching can be performed by, as in Embodiment 1, relatively shifting one of the paired parallax images with respect to the other one thereof to decide the shift position where the correlation between the parallax images becomes maximum. The position matching can also be performed by deciding the shift position where the square sum of the difference components between the paired parallax images becomes minimum. Changing a shift amount to the shift position according to the object distance information enables minimization of displacement in the position matching due to parallax even in a case where distances to multiple objects are mutually different.

Processes at steps S17 to S21 correspond to those at steps S16 to S20 in Embodiment 1, so that description thereof is omitted.

As described above, this embodiment also can decide the unnecessary image component, which is generated due to the unnecessary light (ghost), by using the parallax images produced by one image capturing. That is, this embodiment also can decide the unnecessary image component included in a captured image without performing image capturing multiple times. Moreover, this embodiment determines whether or not to perform the decision of the unnecessary image component by using the image capturing condition, and therefore can avoid that the image processing speed is decreased and the image quality is deteriorated due to erroneous detection by not performing an unnecessary image process in the case where it is clear that no unnecessary image component is generated. Thus, this embodiment also can provide a high quality captured image in which the decided unnecessary image component is sufficiently removed or reduced.

### Embodiment 3

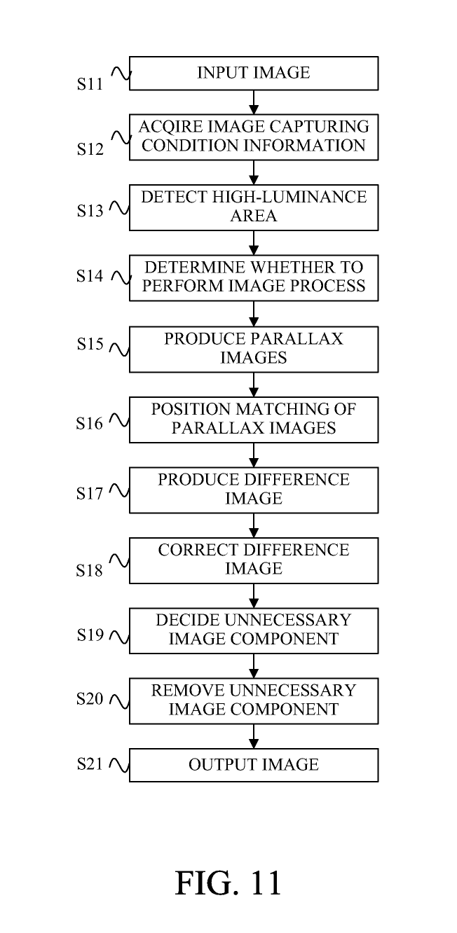

FIG. 11 shows a flowchart showing another modified example (as a third embodiment of the present invention) of the procedure of the above-described image process to decide the unnecessary image component, which is a third embodiment (Embodiment) of the present invention.

Processes at steps S11 and S12 are same as those in Embodiment 1, so that description thereof is omitted.

At step S13, the system controller 210 causes the image processor 204 to detect presence or absence of a high-luminance area from the input image (parallax images). The high-luminance area includes, for example, an area SUN shown in FIG. 8 where a high-intensity light source such as a sun exists, an area shining by reflection of sunlight and a brighter area where a headlight of a car, a street lamp or the like exists than its surroundings.

Next, at step S14, the system controller 210 determines whether or not to perform the image process to decide and remove the unnecessary image component by using the above-mentioned image capturing condition information, the determination information and a detection result of the high-luminance area. As shown in FIG. 5B, the unnecessary light is mainly caused by intense light from a high-intensity light source such as the sun, and therefore, a high-luminance area existing in the input image increases the possibility that the unnecessary light is generated. Accordingly, when the high-luminance area is detected, it is desirable to make the above determination by using the determination information in which the image capturing condition area P shown in FIG. 13 is enlarged.

Processes at steps S15 to S21 correspond to those at steps S14 to S20 in Embodiment 1, so that description thereof is omitted.

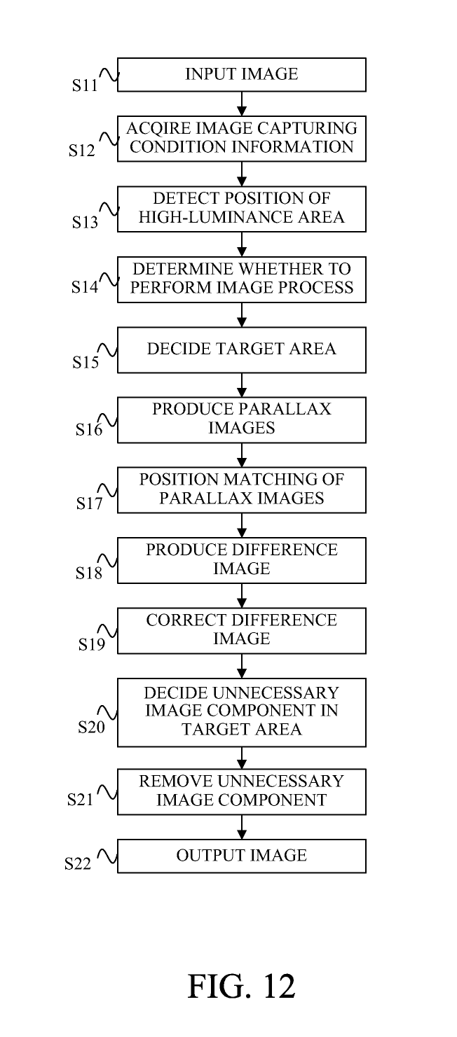

In addition, FIG. 12 is a flowchart showing another modified example of the procedure of the above-described image process to decide the unnecessary image component.

Processes at steps S11 and S12 are same as those in Embodiment 1, so that description thereof is omitted.

At step S13, the system controller 210 causes, as well as the above-described modified example, the image processor 204 to detect presence or absence of the high-luminance area from the input image (parallax images). Moreover, if the high-luminance area is present, the system controller 210 detects a position thereof (coordinates in the image).

Next, at step S14, the system controller 210 determines whether or not to perform the image process to decide and remove the unnecessary image component by using the above-mentioned image capturing condition information, the determination information and a detection result of the high-luminance area.

Next, at step S15, the system controller 210 causes the image processor 204 to decide a target area on which decision of the unnecessary image component is made depending on the position of the high-luminance area. Description of this target area will be made with reference to FIG. 8. In FIG. 8, reference character SUN denotes the above-mentioned high-luminance area. The image processor 204 divides the input image into areas A, B and C. In the area B the unnecessary light is generated, and therefore the decision of the unnecessary image component is made only in the area B. On the other hand, it is clear that no unnecessary image component is generated in the areas A and C, so that it is not necessary to perform the decision in the areas A and C.

Processes at steps S16 to S19 correspond to those at steps S14 to S17 in Embodiment 1, so that description thereof is omitted.

Next, at step S20, the image processor 204 decides, for the image acquired at step S19, an image component remaining in the target area decided at step S15 as the unnecessary image component.

Processes at steps S21 and S22 correspond to those at steps S19 and S20 in Embodiment 1, so that description thereof is omitted.

As described above, this embodiment also can decide the unnecessary image component, which is generated due to the unnecessary light (ghost), by using the parallax images produced by one image capturing. That is, this embodiment also can decide the unnecessary image component included in a captured image without performing image capturing multiple times. Moreover, this embodiment determines whether or not to perform the decision of the unnecessary image component by using the image capturing condition and the detection result of the high-luminance area, and therefore can avoid that the image processing speed is decreased and the image quality is deteriorated due to erroneous detection by not performing an unnecessary image process in the case where it is clear that no unnecessary image component is generated. Thus, this embodiment also can provide a high quality captured image in which the decided unnecessary image component is sufficiently removed or reduced.

### Embodiment 4

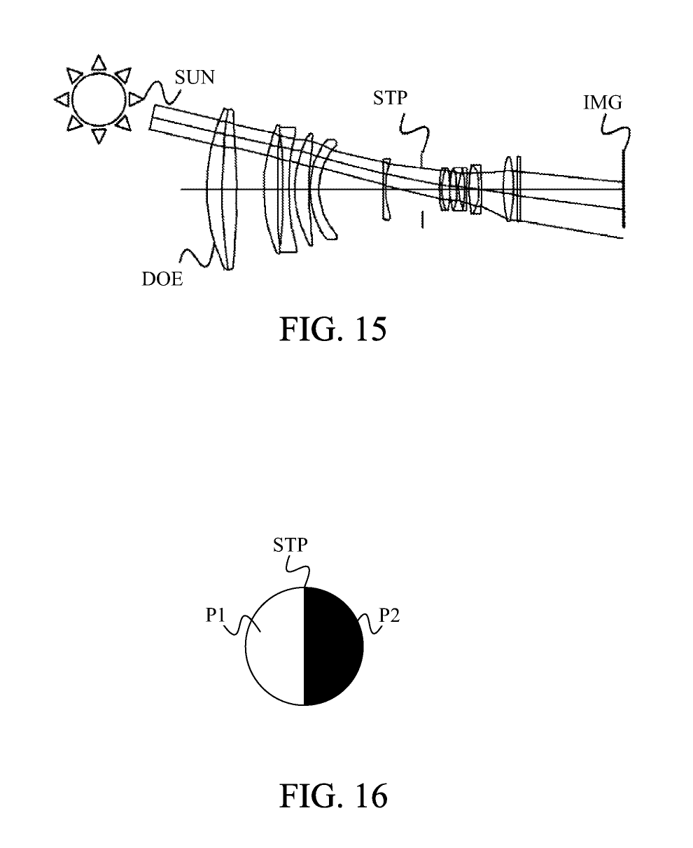

FIG. 15 shows a configuration of an image capturing optical system provided to an image pickup apparatus using an image processing method that is a fourth embodiment (Embodiment 4) of the present invention. In FIG. 15, reference character STP denotes an aperture stop. Reference character IMG denotes an image pickup surface where the image sensor 102 shown in FIG. 4 is disposed.

FIG. 15 shows that unnecessary diffracted light generated by entering of intense light from a sun as an example of high-luminance objects into the image capturing optical system and diffracted at a diffraction surface of a diffractive optical element DOE reaches the image pickup surface IMG. Moreover, FIG. 16 shows, of the aperture stop STP (in other words, of the exit pupil of the image capturing optical system), P1 and P2 pupil areas through which light fluxes entering the G1 and G2 pixels shown FIG. 3 respectively pass. In the case shown in FIG. 15, the light from the high-luminance object (sun) mostly passes through one pupil area of the aperture stop STP. That is, most of the unnecessary diffracted light passes through the P1 pupil area, and little unnecessary diffracted light passes through the P2 pupil area. Thus, the unnecessary diffracted light enters the G1 pixel, but almost no unnecessary diffracted light enters the G2 pixel.

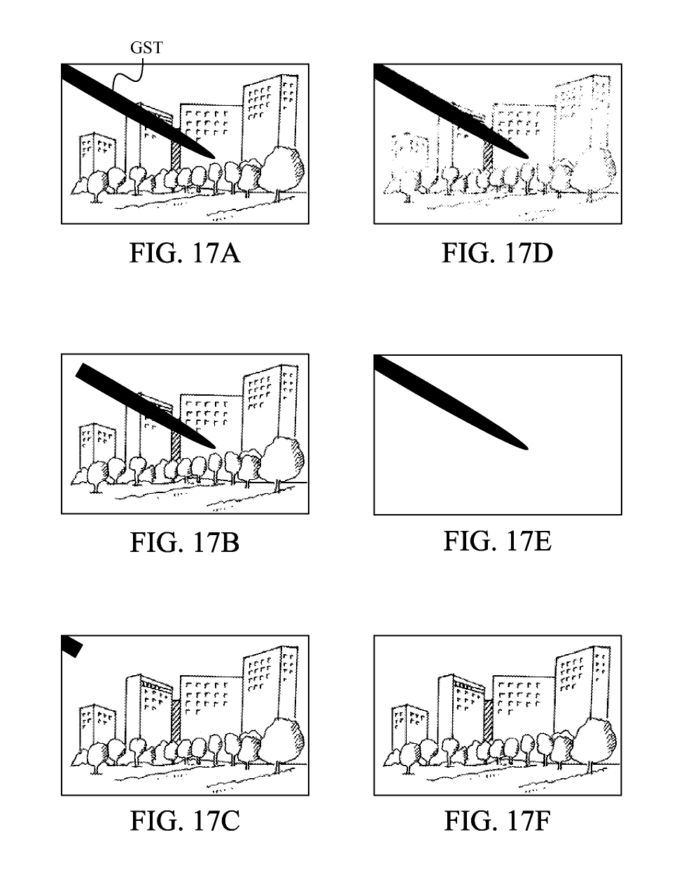

Description will be made of a method of deciding, in paired parallax images produced by image capturing, an unnecessary image component corresponding to the unnecessary diffracted light in this embodiment with reference to FIGS. 17A to 17F. FIG. 17A shows a captured image produced by image capturing without the pupil division described in Embodiment 1. This captured image includes objects such as buildings and trees existing therearound. Black needle-like shaped areas with reference character GST show an unnecessary image component that is an image component formed by the unnecessary diffracted light (ghost).

FIGS. 17B and 17C respectively show paired parallax images acquired as results of photoelectric conversion of the light fluxes passing through the P1 and P2 pupil areas by the G1 and G2 pixel groups. These paired parallax images have difference (difference components) corresponding to parallax in image components of the objects (buildings and trees). The parallax image shown in FIG. 17B includes the unnecessary image component GST having a shape like a needle extending from its near-base portion to its tip, and the parallax image shown in FIG. 17C includes the unnecessary image component GST having a shape like a base portion of the needle.

FIG. 17D shows a difference image acquired by the position matching (described in Embodiment 1) of the paired parallax images. This difference image includes, as difference of the paired parallax images, an object parallax component and an unnecessary image component GST.

FIG. 17E shows the unnecessary image component remaining after a correction process to remove the object parallax component has been performed on the difference image shown in FIG. 17D. Performing the process thus causing the unnecessary image component of the difference image, that is, isolating or extracting the unnecessary image component enables decision of the unnecessary image component.

Then, performing the correction process described in Embodiment 1 to remove or reduce the decided unnecessary image component on an image to be output enables acquisition of an output image in which the unnecessary image component is mostly removed as shown in FIG. 17F.

The processes shown in FIGS. 17D to 17F are performed by the system controller 210 and the image processor 204 shown in FIG. 4 according to the flowcharts described in Embodiment 1 (FIG. 9), Embodiment 2 (FIG. 10) and Embodiment 3 (FIGS. 11 and 12).

As described above, this embodiment can decide the unnecessary image component, which is generated due to the unnecessary diffracted light, by using the parallax images produced by one image capturing. That is, this embodiment also can decide the unnecessary image component included in a captured image without performing image capturing multiple times. Moreover, this embodiment also determines whether or not to perform the decision of the unnecessary image component by using the image capturing condition, and therefore can avoid that the image processing speed is decreased and the image quality is deteriorated due to erroneous detection by not performing an unnecessary image process in the case where it is clear that no unnecessary image component is generated. Thus, this embodiment also can provide a high quality captured image in which the decided unnecessary image component is sufficiently removed or reduced.

### Embodiment 5

Next, description of a fifth embodiment (Embodiment 5) of the present invention will be made. “Light Field Photography with a Hand-held Plenoptic Camera” (Stanford Tech Report CTSR 2005-2) by Ren. Ng et al. proposes “Plenoptic Camera”. Using a technique called “Light Field Photography” in this “Plenoptic Camera” enables acquisition of information on positions and angles of light rays from an object side.

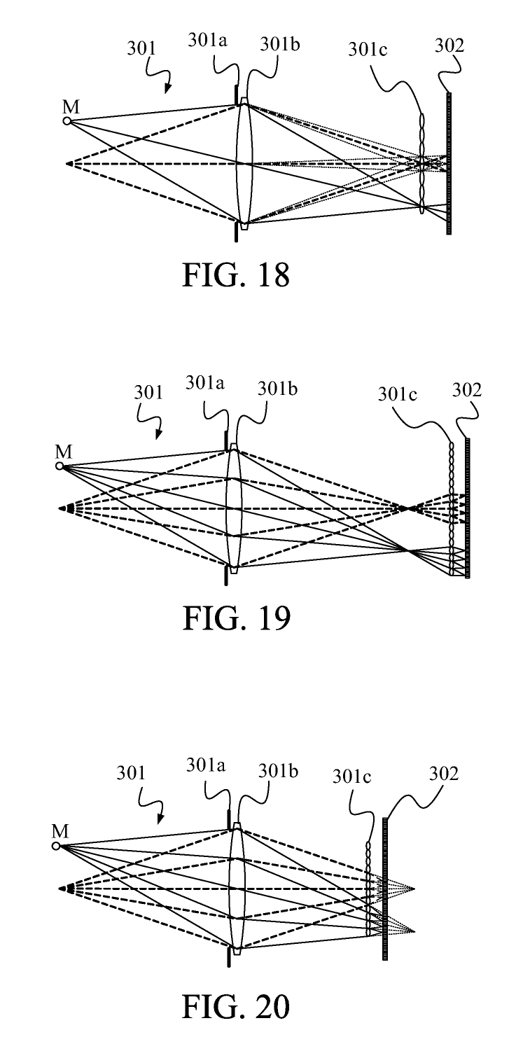

FIG. 18 shows a configuration of an image capturing system of the “Plenoptic Camera”. An image capturing optical system 301 is constituted by a main lens (image capturing lens 301b and an aperture stop 301a) and a microlens array 301c that is disposed at an imaging position of the image capturing optical system 301. At a rear of the microlens array 301c, an image sensor 302 is disposed.

The microlens array 301c serves as a separator that prevents mixing of light rays passing through a certain point M in an object space and light rays passing through a point near the point M on the image sensor 302.

As understood from FIG. 18, an upper ray, a principal ray and a lower ray from the point M are respectively received by different pixels, which makes it possible to capture the light rays passing through the point M, separately from one another according to their angles.

Moreover, “Full Resolution Light Field Rendering” (Adobe Technical Report January 2008) by Todor Georgive et al. proposes, as a method for acquiring information (Light Field) on positions and angles of light rays, a method showing in FIGS. 19 and 20.

The image capturing system shown in FIG. 19 in which the microlens array 301c is disposed at a rear of the imaging position of the main lens 301b causes the light rays passing through a point M to reform images on the image sensor 302, which makes it possible to capture the light rays separately from one another according to their angles. On the other hand, the image capturing system shown in FIG. 20 in which the microlens array 301c is disposed at a front of the imaging position of the main lens 301b causes the light rays passing through a point M to reform images on the image sensor 302, which makes it possible to capture the light rays separately from one another according to their angles. The image capturing systems shown in FIGS. 19 and 20 are same in that both divide light fluxes passing through a pupil of the image capturing optical system 301 depending on their pass areas (pass positions).

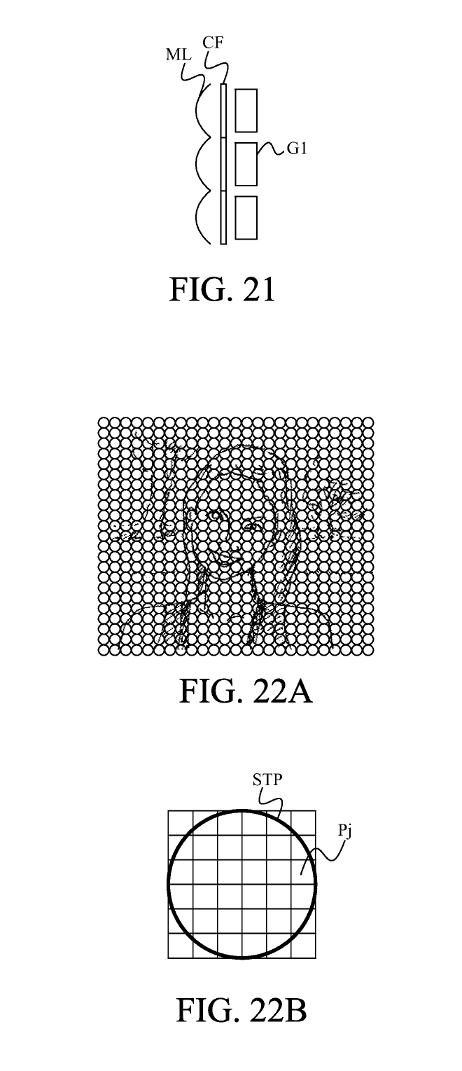

Moreover, both the image capturing systems shown in FIGS. 19 and 20 can use, as the image sensor 302, a conventional image sensor in which one microlens and one light-receiving portion (G1) form a pair as shown in FIG. 21.

The image capturing optical system 301 shown in FIG. 18 provides an image shown in FIG. 22A. FIG. 22B shows one of multiple circles shown in FIG. 22A. One circle corresponds to the aperture stop STP, and its inside area is divided by multiple pixels Pj (j=1, 2, 3, . . . ). This configuration provides a pupil intensity distribution in one circle.

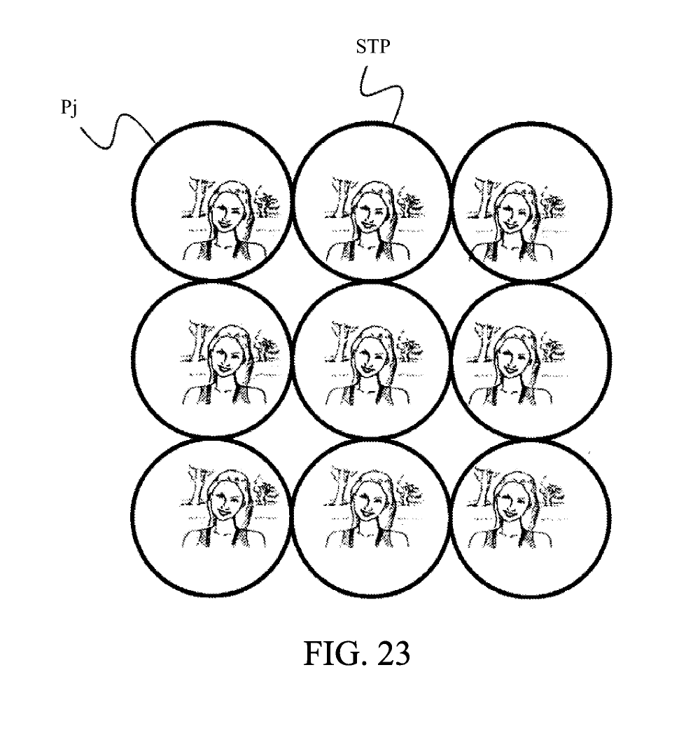

Moreover, each of the image capturing optical systems 301 shown in FIGS. 19 and 20 provides parallax images shown in FIG. 23. Performing reconstruction by arranging the pixels Pj included in the respective circles (aperture stops STP) in the image shown in FIG. 22A also provides multiple parallax images shown in FIG. 23.

As described in Embodiments 1 to 4, the unnecessary light such as the ghost and the unnecessary diffracted light passes through an off-centered area of the pupil. Thus, using the image processing method described in any one of Embodiments 1 to 4 in the image pickup apparatus of this embodiment performing image capturing with the pupil division enables decision of the unnecessary image component. In other words, Embodiments 1 to 4 described the case where the pupil of the image capturing optical system is divided into two pupil areas, but this embodiment describes the case where the pupil is divided into more number of pupil areas.

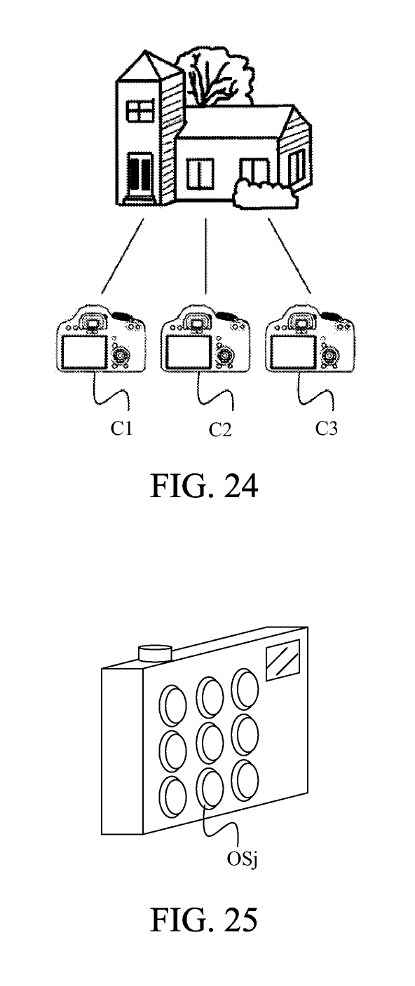

FIG. 24 shows still another exemplary case of performing image capturing of a same object by using multiple cameras to produce parallax images. The image processing method described in any one of Embodiments 1 to 4 can be used for this case. The cameras C1, C2 and C3 are actually separated from one another, but can be regarded as being one image pickup apparatus whose pupil is divided into three pupil areas.

Furthermore, as shown in FIG. 25, providing multiple image capturing optical systems OSj (j=1, 2, 3, . . . ) to one image pickup apparatus enables the pupil division.

### Embodiment 6

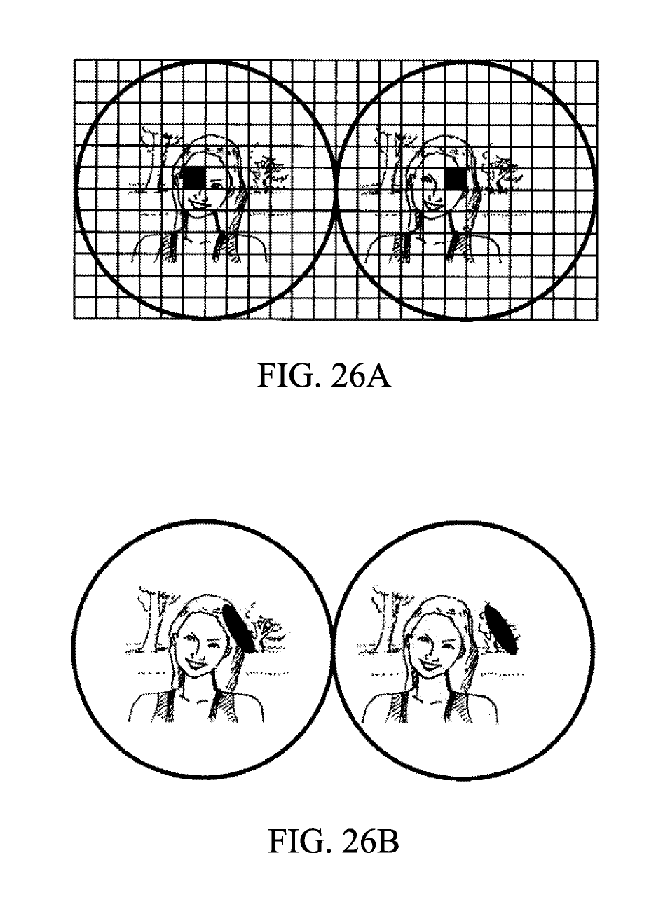

Although the above embodiments described the cases of deciding and removing the unnecessary image component formed by the unnecessary light such as the ghost and the unnecessary diffracted light, there are other unnecessary image components formed by pixel defect in an image sensor and dust adhering to an image capturing optical system. FIG. 26A shows an example of parallax images produced by using the image sensor including the pixel defect. FIG. 26B shows an example of parallax images when dust adheres to the image capturing optical system. Black pixels in these figures show the unnecessary image components formed by defect pixels (non-functional pixels) or by blocking of light by the dust. Also in these cases, the image processing method described in any one of Embodiments 1 to 4 can decide and remove the unnecessary image component from the parallax images.

Moreover, although each of the above embodiments described the cases of removing or reducing the unnecessary image component from the image, a correction process may be performed which adds another unnecessary image component to the image by using the decided unnecessary image component. For example, the parallax images shown in FIG. 23 include images including ghost (unnecessary image component) and images including no ghost. When desiring a reconstructed image including the ghost, the decided unnecessary image component may be added to each parallax image or the ghost may be added to the reconstructed image.

Although each of Embodiments 1 to 6 described the image pickup apparatus using the image processing method, that is, provided with an image processing apparatus, the image processing method may be implemented by an image processing program installed from a non-transitory computer-readable storage medium 250 (shown in FIG. 4) such as an optical disk or a semiconductor memory into a personal computer. In this case, the personal computer corresponds to an image processing apparatus as another embodiment of the present invention. The personal computer takes in (acquires) an input image produced by image capturing by an image pickup apparatus before the image process, and performs the image process by the image processing method on the input image to output a resulting image.

While the present invention has been described with reference to exemplary embodiments, it is to be understood that the invention is not limited to the disclosed exemplary embodiments. The scope of the following claims is to be accorded the broadest interpretation so as to encompass all such modifications, equivalent structures and functions.

This application claims the benefit of Japanese Patent Application Nos. 2012-019436, filed on Feb. 1, 2012, and 2012-226445, filed on Oct. 11, 2012 which are hereby incorporated by reference herein in their entirety.

What is claimed is:

1. An image processing method comprising the steps of:
acquiring parallax images having parallax and produced by image capturing of an object;
performing position matching of the parallax images to calculate difference between the parallax images; and
deciding, in the difference, an unnecessary image component different from an image component corresponding to the parallax.

2. An image processing method according to claim 1, further comprising the steps of:
acquiring image capturing condition information on a focal length and an aperture value of an image capturing optical system used for the image capturing; and
providing determination information for determining whether or not to perform an image process for deciding the unnecessary image component on a basis of the image capturing condition information, and deciding whether or not to perform the image process for deciding the unnecessary image component by using the image capturing condition information and the determination information,
wherein the method performs, when determining to perform the image process for deciding the unnecessary image component, the position matching of the parallax images.

3. An image processing method according to claim 2, further comprising the step of:
producing, from the parallax images, information on a distance to the object,
wherein the method performs, when determining to perform the image process for deciding the unnecessary image component, the position matching of the parallax images depending on the distance.

4. An image processing method according to claim 2, further comprising the steps of:
detecting a high-luminance area in the parallax images; and
determining whether or not to perform the image process for deciding the unnecessary image component depending on a detection result of the high-luminance area and the image capturing condition information.

5. An image processing method according to claim 2, further comprising the steps of:
detecting a position of a high-luminance area in the parallax images;
deciding a target area for deciding the unnecessary image component; and
determining, depending on a detection result of the position of the high-luminance area and the image capturing condition information, whether or not to perform the image process for deciding the unnecessary image component,
wherein the method decides, when determining to perform the image process for deciding the unnecessary image component, the unnecessary image component in the target area.

6. An image processing method according to claim 1, wherein the parallax images are produced by an image pickup apparatus that (a) introduces light fluxes passing through mutually different areas of a pupil of an image capturing optical system used for the image capturing to mutually different pixels of an image sensor and (b) causes the image sensor to perform photoelectric conversion of the light fluxes.

7. An image processing method according to claim 1, wherein the parallax images are produced by an image pickup apparatus that is provided with an image sensor including (a) a plurality of pairs of pixels respectively photoelectrically converting light fluxes passing through mutually different areas of a pupil of an image capturing optical system used for the image capturing and (b) microlenses each provided to each pair of the pixels.

8. An image processing method according to claim 1, further comprising the step of:
producing, by using the parallax images, an output image in which the unnecessary image component is removed or reduced.

9. An image processing method according to claim 1, further comprising the step of:
performing, by using the unnecessary image component, a correction process to add another unnecessary image component to the parallax images.

10. An image processing apparatus comprising:
an image acquiring part configured to acquire parallax images having parallax and produced by image capturing of an object;
a difference calculating part configured to perform position matching of the parallax images to calculate difference between the parallax images; and
an unnecessary image component deciding part configured to decide, in the difference, an unnecessary image component different from an image component corresponding to the parallax.

11. An image processing apparatus according to claim 10, further comprising:
an image capturing condition information acquiring part configured to acquire image capturing condition information on a focal length and an aperture value of an image capturing optical system used for the image capturing; and
a determining part configured to have determination information for determining whether or not to perform an image process for deciding the unnecessary image component on a basis of the image capturing condition information and configured to decide whether or not to perform the image process for deciding the unnecessary image component by using the image capturing condition information and the determination information,
wherein the difference calculating part is configured to perform, when determination to perform the image process for deciding the unnecessary image component is made, the position matching of the parallax images.

12. An image pickup apparatus comprising:
an image capturing system configured to perform image capturing of an object to produce parallax images having parallax; and
an image processing apparatus comprising:
a difference calculating part configured to perform position matching of the parallax images to calculate difference between the parallax images; and
an unnecessary image component deciding part configured to decide, in the difference, an unnecessary image component different from an image component corresponding to the parallax.

13. An image pickup apparatus according to claim 12, wherein the image processing apparatus further comprises:
an image capturing condition information acquiring part configured to acquire image capturing condition information on a focal length and an aperture value of an image capturing optical system used for the image capturing; and
a determining part configured to have determination information for determining whether or not to perform an image process for deciding the unnecessary image component on a basis of the image capturing condition information and configured to decide whether or not to perform the image process for deciding the unnecessary image component by using the image capturing condition information and the determination information,
wherein the difference calculating part is configured to perform, when determination to perform the image process for deciding the unnecessary image component is made, the position matching of the parallax images.

14. A non-transitory computer-readable storage medium storing an image processing program for causing a computer to execute an image processing operation, the image processing operation comprising:
acquiring parallax images having parallax and produced by image capturing of an object;
performing position matching of the parallax images to calculate difference between the parallax images; and
deciding, in the difference, an unnecessary image component different from an image component corresponding to the parallax.

15. A non-transitory computer-readable storage medium according to claim 14, the image processing operation further comprising:
acquiring image capturing condition information on a focal length and an aperture value of an image capturing optical system used for the image capturing; and
providing determination information for determining whether or not to perform an image process for deciding the unnecessary image component on a basis of the image capturing condition information, and deciding whether or not to perform the image process for deciding the unnecessary image component by using the image capturing condition information and the determination information,
wherein the image processing operation performs, when determination to perform the image process for deciding the unnecessary image component is made, the position matching of the parallax images.
